(19) United States
(12) Patent Application Publication
(10) Pub. No.: US 2022/0067459 A1
(43) Pub. Date: Mar. 3, 2022

(54) DYNAMIC POLICY PROGRAMMING FOR CONTINUOUS ACTION SPACES

(71) Applicant: International Business Machines Corporation, Armonk, NY (US)

(72) Inventor: RYO IWAKI, Tokyo (JP)

(21) Appl. No.: 17/008,773

(22) Filed: Sep. 1, 2020

(51) Int. Cl. G06K 9/62; G06N 3/08; G06N 20/00

(52) U.S. Cl. CPC G06K 9/6297; G06N 20/00; G06N 3/08; G06K 9/6262

(57) ABSTRACT

A method, system, and computer program product for dynamic policy programming in continuous action spaces are provided. The method generates a replay buffer including a set of transitions from a set of states. A plurality of transitions are sampled from the replay buffer as a set of samples. The method generates an action value based on a dynamic policy programming (DPP) recursion using the set of samples and a first hyperparameter. The policy is evaluated by computing a KL divergence using the set of samples, the action value and a second hyperparameter. The current policy is evaluated using the action value and a DPP-based error. The method generates a subsequent policy by updating the current policy by minimizing a sum of two KL divergences and using a third hyperparameter. The second KL divergence is computed from the current policy and the set of samples.

### BACKGROUND

Value iteration (VI) and policy iteration (PI) have historically been used to determine value function and policy in Markov decision processes. Dynamic policy programming (DPP) is an approximation-error-tolerant extension of VI and PI. DPP is used in domains with discrete action spaces. However, DPP is generally inapplicable to continuous action domains.

### SUMMARY

According to an embodiment described herein, a computer-implemented method for dynamic policy programming in continuous action spaces is provided. The method generates a replay buffer which includes a set of transitions from a set of states, a set of actions based on a current policy, a set of subsequent states based on the set of actions, and a set of rewards based on the set of actions. A plurality of transitions is sampled from the replay buffer as a set of samples. The method generates an action value based on a DPP recursion using the set of samples and a first hyperparameter. The current policy is evaluated by computing a KL divergence using the set of samples, the action value and a second hyperparameter. The method generates a subsequent policy by updating the current policy by minimizing a sum of two KL divergences using a third hyperparameter. The second KL divergence is computed from the current policy and the set of samples.

According to an embodiment described herein, a system for dynamic policy programming in continuous action spaces is provided. The system includes one or more processors and a computer-readable storage medium, coupled to the one or more processors, storing program instructions that, when executed by the one or more processors, cause the one or more processors to perform operations. The operations generate a replay buffer which includes a set of transitions from a set of states, a set of actions based on a current policy, a set of subsequent states based on the set of actions, and a set of rewards based on the set of actions. A plurality of transitions is sampled from the replay buffer as a set of samples. The operations generate an action value based on a DPP recursion using the set of samples and a first hyperparameter. The current policy is evaluated by computing a KL divergence using the set of samples, the action value and a second hyperparameter. The method generates a subsequent policy by updating the current policy by minimizing a sum of two KL divergences using a third hyperparameter. The second KL divergence is computed from the current policy and the set of samples.

According to an embodiment described herein, a computer program product for dynamic policy programming in continuous action spaces is provided. The computer program product includes a computer-readable storage medium having program instructions embodied therewith, the program instructions being executable by one or more processors to cause the one or more processors to generate a replay buffer which includes a set of transitions from a set of states, a set of actions based on a current policy, a set of subsequent states based on the set of actions, and a set of rewards based on the set of actions. A plurality of transitions is sampled from the replay buffer as a set of samples. The computer program product generates an action value based on a DPP recursion using the set of samples and a first hyperparameter. The current policy is evaluated by computing a KL divergence using the set of samples, the action value and a second hyperparameter. The method generates a subsequent policy by updating the current policy by minimizing a sum of two KL divergences using a third hyperparameter. The second KL divergence is computed from the current policy and the set of samples.

### BRIEF DESCRIPTION OF THE DRAWINGS

FIG. 1 depicts a block diagram of a computing environment for implementing concepts and computer-based methods, according to at least one embodiment.

FIG. 2 depicts a flow diagram of a computer-implemented method for dynamic policy programming in continuous action spaces, according to at least one embodiment.

FIG. 3 depicts a flow diagram of a computer-implemented method for dynamic policy programming in continuous action spaces, according to at least one embodiment.

FIG. 4 depicts a block diagram of a computing system for dynamic policy programming in continuous action spaces, according to at least one embodiment.

FIG. 5 is a schematic diagram of a cloud computing environment in which concepts of the present disclosure may be implemented, in accordance with an embodiment of the present disclosure.

FIG. 6 is a diagram of model layers of a cloud computing environment in which concepts of the present disclosure may be implemented, in accordance with an embodiment of the present disclosure.

### DETAILED DESCRIPTION

The present disclosure relates generally to methods for dynamic policy programming in continuous action spaces. More particularly, but not exclusively, embodiments of the present disclosure relate to a computer-implemented method for an approximation-error-tolerant reinforcement learning method to extend DPP into continuous action spaces. The present disclosure relates further to a related system for DPP in continuous action spaces, and a computer program product for operating such a system.

DPP is applicable to domains with discrete action spaces, but generally inapplicable to continuous action spaces. In some systems, VI and PI are classical methods to acquire optimal or theoretically optimal value function and optimal policy in Markov decision processes. When VI and PI are approximated from samples, asymptotic performance loss of policy may be characterized by a supremum norm of value approximation error in each iteration, as a policy is iterated toward an ultimate change. When used with respect to DPP, asymptotic performance loss may be characterized by a mean of value approximation errors. When the means of approximation errors are equal to or sufficiently close to zero, DPP may be considered to achieve an optimal policy asymptotically.

Although DPP may be used in discrete action spaces, DPP is inapplicable to continuous action spaces. Embodiments of the present disclosure enable extension of DPP into continuous action spaces. In extending DPP to continuous action spaces, embodiments of the present disclosure enable approximation-error-tolerant and fast learning reinforcement learning methods and techniques that operate in continuous action spaces. By extending DPP to continuous action spaces, embodiments of the present disclosure enable use of DPP to iteratively modify action values and modify or update policies in a continuous action domain. Embodiments of the present disclosure enable successful learning of a continuous action task, swing-up, and stabilization, to which DPP may not otherwise be applied.

Some embodiments of the concepts described herein may take the form of a system or a computer program product. For example, a computer program product may store program instructions that, when executed by one or more processors of a computing system, cause the computing system to perform operations described above with respect to the computer-implemented method. By way of further example, the system may comprise components, such as processors and computer-readable storage media. The computer-readable storage media may interact with other components of the system to cause the system to execute program instructions comprising operations of the computer-implemented method, described herein. For the purpose of this description, a computer-usable or computer-readable medium may be any apparatus that may contain means for storing, communicating, propagating, or transporting the program for use, by, or in connection with, the instruction execution system, apparatus, or device.

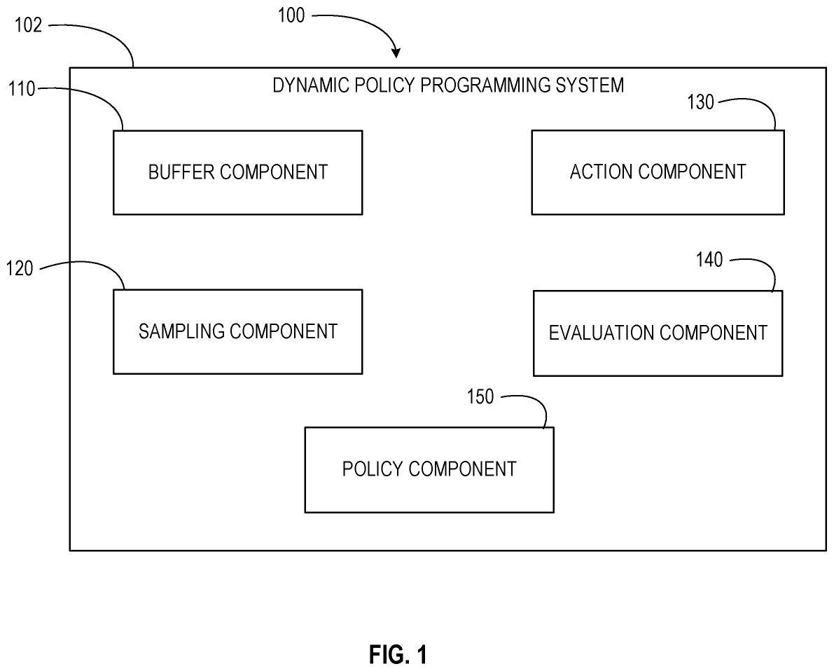

Referring now to FIG. 1, a block diagram of an example computing environment 100 is shown. The present disclosure may be implemented within the example computing environment 100. In some embodiments, the computing environment 100 may be included within or embodied by a computer system, described below. The computing environment 100 may include a dynamic policy programming system 102. The dynamic policy programming system 102 may comprise a buffer component 110, a sampling component 120, an action component 130, an evaluation component 140, and a policy component 150. The buffer component 110 generates replay buffers. The sampling component 120 samples transitions from the replay buffers. The action component 130 generates and updates action values. The evaluation component 140 evaluates current policies associated with action values and transitions within the replay buffer. The policy component 150 generates subsequent policies based on current policies, KL divergence, and DPP-based error values. Although described with distinct components, it should be understood that, in at least some embodiments, components may be combined or divided, and/or additional components may be added without departing from the scope of the present disclosure.

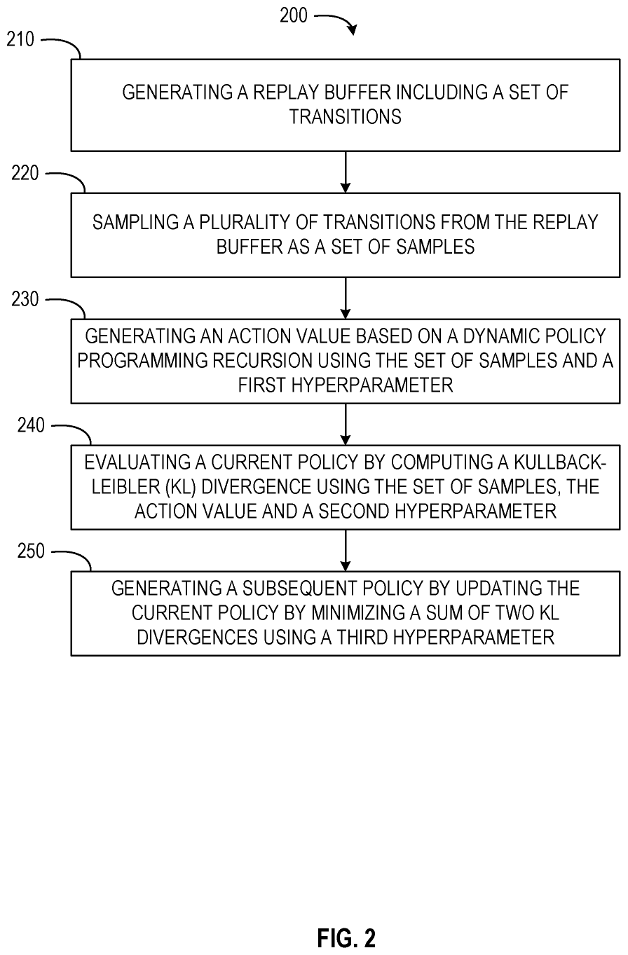

Referring now to FIG. 2, a flow diagram of a computer-implemented method 200 is shown. The computer-implemented method 200 is a method for DPP in continuous action spaces. In some embodiments, the computer-implemented method 200 may be performed by one or more components of the computing environment 100, as described in more detail below.

At operation 210, the buffer component 110 generates a replay buffer. The replay buffer includes a set of transitions. The set of transitions may be generated from a set of states, a set of actions based on a current policy, a set of subsequent states based on the set of actions, and a set of rewards based on the set of actions. In some embodiments, each transition included in the replay buffer is representative of a set of related elements or operations occurring in a continuous action space. The continuous action space may be understood as a sample space of a Gaussian. In some instances, each transition represents a first state, an action based on a current policy, a subsequent state based on the first state and the action, and a reward based on the first state and the action. The first state may be a current state in which the continuous action space is operating at a time when the action is selected or performed.

In some embodiments, as actions are performed within a continuous action domain or environment, transitions are recorded by the buffer component 110. Performance of the action in the continuous action environment may be understood as an environment step operation. The environment step operation may perform the action and collect or initiate collection of a transition for which the action is a part. The buffer component 110 appends the transitions to the replay buffer.

Recording or appending of a transition may be initiated by detecting an action being chosen or selected within the continuous action domain. Once the action is detected, the buffer component 110 identifies or observes a state of the continuous action domain at a time the action was detected. The buffer component 110 may then detect a next state and a reward that occur after the action is detected and implemented or performed. In some embodiments, tokens, bits, or representations of the state, the action, the next state, and the reward may be appended to the replay buffer as a representation of a single transition. The buffer component 110 may append transitions to the replay buffer in real-time or near real-time.

At operation 220, the sampling component 120 samples a plurality of transitions from the replay buffer. The plurality of transitions may be used as a set of samples. The set of samples may be considered off-policy data as the policies change or are employed based on selected actions. Sampling the plurality of transitions may be a portion of a gradient step operation within the continuous action domain. In some embodiments, the plurality of transitions is used to generate or update action values and evaluate or update policies based on DPP techniques. The sampling component 120 may sample the plurality of transitions at random. Although described as being sampled at random, the sampling component 120 may sample the replay buffer using any suitable sampling algorithm or methodology. The sampling component 120 may sample a fixed number of transitions from the replay buffer. The fixed number of transitions may be any suitable number of transitions between one and an upper limit of transitions currently within the replay buffer. In some embodiments, the sampling component 120 samples transitions iteratively or on demand. The sampling component 120 may iteratively or on demand sample the transitions until a stop condition occurs. The stop condition may be modification of a current policy or determination of a satisfactory nature of a current or newly updated policy. When iteratively or on demand sampling the transitions, the sampling component 120 may sample the transitions individually or in sample groups including more than one transition.

At operation 230, the action component 130 generates an action value based on a DPP recursion. The DPP recursion may at least a portion of the set of samples and a first hyperparameter. The action value may be learnt by iteration of DPP with an additional hyperparameter, such as the first hyperparameter. The first hyperparameter may affect DPP recursion by modifying performance of the DPP at various stages of the recursion, depending on a value of the first hyperparameter. In some instances, the first hyperparameter may be regarded as a continuous variant of expected state-action-reward-state-action (Sarsa) with off-policy updates. In some embodiments, a policy π is applicable to continuous action spaces and is used as an actor. The action value may be learnt by minimization of DPP-based error.

The generation of the action value may be a further portion of the gradient step operation. In some embodiments, the action component 130 generates the action value by updating a preexisting action value with a subsequent value distinct from the original or preexisting action value. In some instances, updating the action value may be an initial operation in a policy evaluation operation.

In some embodiments, the evaluation component 130 approximates the DPP-based error using double Q learning and at least one target network from samples associated with the first hyperparameter. In some embodiments, the evaluation component 140 approximates the DPP-based error using double Q learning and the first hyperparameter of ι. The evaluation component 140 may use minimization for a Bellman backup term in double Q learning. In such instances, the evaluation component 140 may use “min” for the Bellman backup term, as described above. In some instances, as described in the equations below, the Bellman backup term or operator may be computed as minᵢ Qₖ^{targ, i}. The evaluation component 140 may use maximization for an advantage term in double Q learning. In such instances, the evaluation component 140 may use “max” as the advantage term, as described above. In some instances, the advantage term or function may be computed as maxⱼ Qₖ^{targ, j}. In evaluating the current policy, the evaluation component 140 performs a gradient descent to minimize the DPP-based error.

At operation 240, the evaluation component 140 evaluates the current policy by computing a Kullback-Leibler (KL) divergence using the set of samples, the action value and a second hyperparameter. The KL divergence may be a relative entropy measuring a difference in probability distribution between two probability distributions. The computed KL divergence is the KL divergence between the current policy and softmax policy. The softmax policy may be defined from the current action value and the second hyperparameter, η. In some embodiments, evaluation of the current policy may be a subsequent portion of the gradient step operation.

At operation 250, the policy component 150 generates a subsequent policy. Generation of the subsequent policy may be a subsequent portion of the gradient step operation. The subsequent policy may be generated by updating the current policy by minimizing a sum of two KL divergences using a third hyperparameter, ζ. The first KL divergence is the KL divergence computed at the operation 240. The second KL divergence is the KL divergence between the current policy and the subsequent policy. The second KL divergence is computed by using the set of samples and the current policy.

The optimization (e.g., evaluation of the current policy and generation of the subsequent policy) may be performed, as described above, by reusing stored transition samples. In some embodiments, the combined optimization of operations 230, 240 and 250 may be represented by Equation 1, below.

$${Q}_{k + 1} ( s , a ) = {𝒯}^{{π}_{k}} ( s , a ) + ι ( {Q}_{k} ( s , a ) - {π}_{k} {Q}_{k} ( s ) ) , \\ {π}_{k + 1} = arg {min}_{π} {𝔼}_{s \sim 𝒟} [ {D}_{KL} ( π ( \cdot \vert s ) ‖ \frac{exp ( η {Q}_{k + 1} ( s , \cdot ) )}{Z ( s )} ) + ϛ {D}_{KL} ( π ( \cdot \vert s ) ‖ {π}_{k} ( \cdot \vert s ) ) ] \qquad Equation 1$$

In Equation 1, D_{KL} is a Kullback-Leibler divergence, Z represents a partition function, and D represents a set of transition samples in the replay buffer. As shown in Equation 1, s represents a state, a represents an action, and k represents an iteration. In Equation 1, ηₖ represents a policy at iteration k, Qₖ represents an approximated action value at iteration k, and T^{π}Qₖ represents Bellman backup of the action value under policy π.

In some embodiments, the operations of the method 200 may approximate a monotonic policy improvement under entropy regularization. In such embodiments, the evaluation and generation of policies rewrites a proposed update rule into maximization. Such embodiments may be represented by Equation 2, below.

$${π}_{k + 1} = arg {min}_{π} {η J}_{k} ( π ) , \\ {J}_{k} ( π ) = {𝔼}_{s \sim 𝒟} [ {\sum }_{a ∈ 𝒜} π ( a \vert s ) {A}_{k} ( s , a ) + \frac{1}{η} H ( π ( \cdot \vert s ) ) - \frac{ϛ}{η} {D}_{KL} ( π ( \cdot \vert s ) ‖ {π}_{k} ( \cdot \vert s ) ) ] , \\ {A}_{k} ( s , a ) = {Q}_{k} ( s , a ) - {V}_{k} ( s ) , {V}_{k} ( s ) = \frac{1}{η} log {\sum }_{b ∈ 𝒜} exp ( η {Q}_{k} ( s , b ) ) \qquad Equation 2$$

In some embodiments, updating the action value approximates a proposed iteration from samples, double Q learning, and target networks. Such embodiments use the double Q learning and target networks to stabilize the learning process of the DPP. Such embodiments may be represented by Equation 3, below.

$${y}_{k} ( s , a , {s}^{′} ) = r ( s , a ) + {γmin}_{i ∈ \{ 1 , 2 \}} {Q}_{{ϕ}_{k}^{targ , i}} ( {s}^{′} , {a}_{π}^{′} ) + {ιmax}_{j ∈ \{ 1 , 2 \}} ( {Q}_{{ϕ}_{k}^{targ , j}} ( s , a ) - {Q}_{{ϕ}_{k}^{targ , j}} ( s , {a}_{π} ) ) , \\ {a}_{π} \text{\textasciitilde} {π}_{k} ( \cdot \vert s ) , {a}_{π}^{′} \text{\textasciitilde} {π}_{k} ( \cdot \vert {s}^{′} ) , \\ {ϕ}_{k + 1}^{i} = arg {min}_{ϕ} {𝔼}_{( s , a , {s}^{′} ) \sim 𝒟} [ \frac{1}{2} {( {y}_{k} ( s , a , {s}^{′} ) - {Q}_{{ϕ}^{i}} ( s , a ) )}^{2} ] , ∀ i ∈ \{ 1 , 2 \} \qquad Equation 3$$

In Equation 3, action values are represented by parameters ϕₖ¹ and ϕₖ². These parameters are represented at an iteration k. Two target networks are represented by ϕₖ^{targ, 1} and ϕₖ^{targ, 2}. The two target networks are used and updated with delay. A Bellman operator, as in operation 230, is represented by “min.” An advantage function, as in operation 230, is represented by “max.”

The environment step operations and the gradient step operations may be represented in pseudo code as:

Input: Initial parameters θ, ϕ₁, ϕ₂, hyper-parameters η, ι, ζ

1: ϕᵢ^{targ} ← ϕᵢ for i ∈{1, 2}
2: [symbol] ← Ø
3: for each iteration do
4: for each environment step do
5: sample action αₜ from the policy π_{θ} for current state sₜ
6: observe next state sₜ₊₁ and reward rₜ
7: [symbol] ← [symbol] ∪{(sₜ, aₜ, sₜ₊₁, rₜ)}
8: end for
9: for each gradient step do
10: sample transitions from [symbol]
11: update ϕᵢ for i ∈{1, 2} by gradient descent to perform
12: update θ by gradient descent to perform
13: ϕᵢ^{targ} ← τϕᵢ + (1 − τ) ϕᵢ^{targ} for i ∈{1, 2}
14: end for
15: end for
16: return Optimized parameters θ, ϕ₁, ϕ₂

The pseudo code represents the environment step operation in the “for each environment step” clause and the gradient step operations in the “for each gradient step” clause. In the pseudo code, s represents a state, a represents an action, π_{θ} represents a policy at θ. As depicted in the pseudo code, a policy π with an initial parameter θ is an initial given circumstance. The policy π and the initial parameter θ may represent a neural net with an input of a state and an output as an action with Gaussian noise. Two action value functions Q₁ and Q₂ with initial parameters of ϕ₁ and ϕ₂, respectively, are also taken as a given for the pseudo code example. The two action value functions may represent neural nets whose inputs are state-action pairs and output estimated values. Finally, the pseudo code takes certain hyperparameters as a given. The hyperparameters may be understood as hyperparameters η, ι, ζ.

In some embodiments, upon completion of operation 250, the dynamic policy programming system 102 determines whether the subsequent policy is satisfactory. Where the subsequent policy is satisfactory, the dynamic policy programming system 102 terminates operations until triggered again at a later point in time. Where the subsequent policy is not satisfactory, the dynamic policy programming system 102 may reinitialize one or more components to repeat one or more operations of the method 200, described above. When repeated, the operations of the method 200 may sample one or more different transitions and use one or more different hyperparameters than were used in a previous iteration of the method 200.

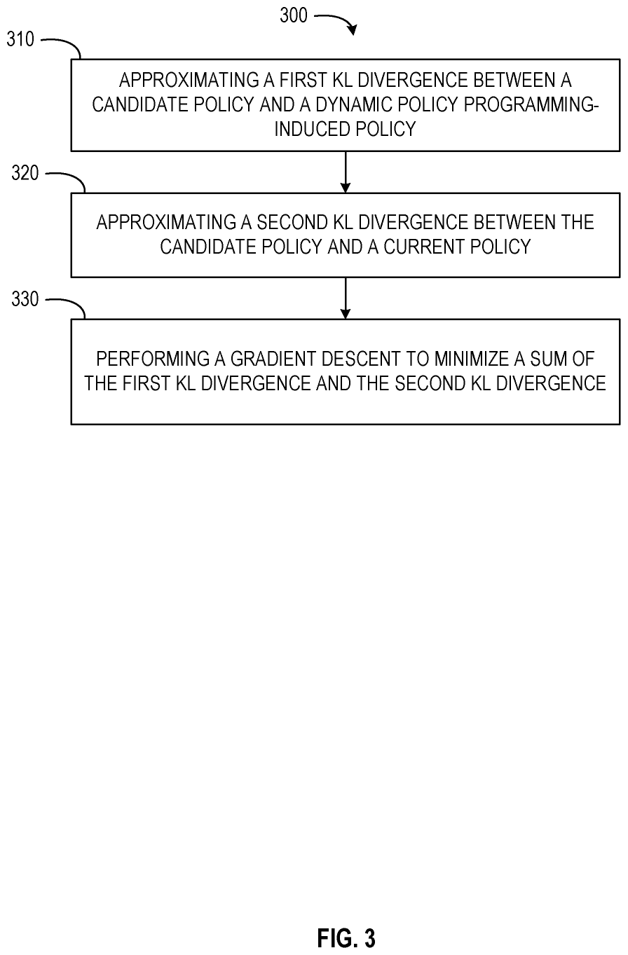

FIG. 3 shows a flow diagram of an embodiment of a computer-implemented method 300 for DPP in continuous action spaces. The method 300 may be performed by or within the computing environment 100. In some embodiments, the method 300 comprises or incorporates one or more operations of the method 200. In some instances, operations of the method 300 may be incorporated as part of or sub-operations of the method 200, such as operation 250.

In operation 310, the policy component 150 approximates a first KL divergence between a candidate policy and a DPP-induced policy from samples associated with a specified hyperparameter. The specified hyperparameter may be a second hyperparameter where a first hyperparameter is used in generating or updating the action value and evaluating the current policy, as in the method 200. The second hyperparameter may be hyperparameter η, described above.

In operation 320, the policy component 150 approximates a second KL divergence between the candidate policy and a current policy. The current policy may be the current policy described in the method 200. The current policy may be the current policy associated with the set of samples in the replay buffer.

In operation 330, the policy component 150 performs a gradient descent to minimize a sum of the first KL divergence and the second KL divergence. The gradient descent may be performed with a third hyperparameter. The third hyperparameter may be hyperparameter ζ, described above.

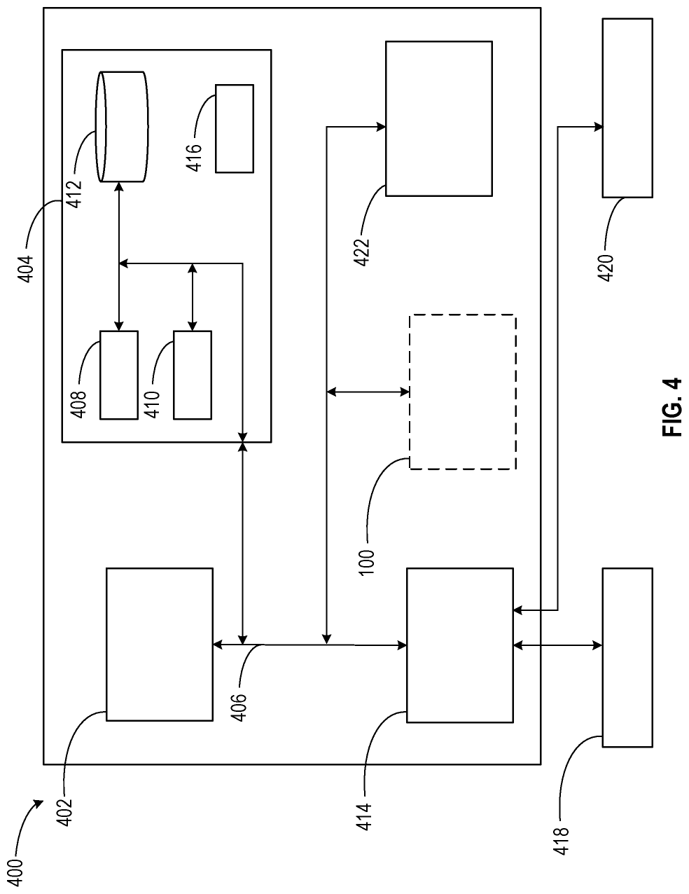

Embodiments of the present disclosure may be implemented together with virtually any type of computer, regardless of the platform is suitable for storing and/or executing program code. FIG. 4 shows, as an example, a computing system 400 (e.g., cloud computing system) suitable for executing program code related to the methods disclosed herein and for DPP in continuous action spaces.

The computing system 400 is only one example of a suitable computer system and is not intended to suggest any limitation as to the scope of use or functionality of embodiments of the present disclosure described herein, regardless, whether the computer system 400 is capable of being implemented and/or performing any of the functionality set forth hereinabove. In the computer system 400, there are components, which are operational with numerous other general purpose or special purpose computing system environments or configurations. Examples of well-known computing systems, environments, and/or configurations that may be suitable for use with computer system/server 400 include, but are not limited to, personal computer systems, server computer systems, thin clients, thick clients, hand-held or laptop devices, multiprocessor systems, microprocessor-based systems, set-top boxes, programmable consumer electronics, network PCs, minicomputer systems, mainframe computer systems, and distributed cloud computing environments that include any of the above systems or devices, and the like. Computer system/server 400 may be described in the general context of computer system-executable instructions, such as program modules, being executed by a computer system 400. Generally, program modules may include routines, programs, objects, components, logic, data structures, and so on that perform particular tasks or implement particular abstract data types. Computer system/server 400 may be practiced in distributed cloud computing environments where tasks are performed by remote processing devices that are linked through a communications network. In a distributed cloud computing environment, program modules may be located in both, local and remote computer system storage media, including memory storage devices.

As shown in the figure, computer system/server 400 is shown in the form of a general-purpose computing device. The components of computer system/server 400 may include, but are not limited to, one or more processors 402 (e.g., processing units), a system memory 404 (e.g., a computer-readable storage medium coupled to the one or more processors), and a bus 406 that couple various system components including system memory 404 to the processor 402. Bus 406 represents one or more of any of several types of bus structures, including a memory bus or memory controller, a peripheral bus, an accelerated graphics port, and a processor or local bus using any of a variety of bus architectures. By way of example, and not limiting, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Computer system/server 400 typically includes a variety of computer system readable media. Such media may be any available media that is accessible by computer system/server 400, and it includes both, volatile and non-volatile media, removable and non-removable media.

The system memory 404 may include computer system readable media in the form of volatile memory, such as random-access memory (RAM) 408 and/or cache memory 410. Computer system/server 400 may further include other removable/non-removable, volatile/non-volatile computer system storage media. By way of example only, a storage system 412 may be provided for reading from and writing to a non-removable, non-volatile magnetic media (not shown and typically called a ‘hard drive’). Although not shown, a magnetic disk drive for reading from and writing to a removable, non-volatile magnetic disk (e.g., a ‘floppy disk’), and an optical disk drive for reading from or writing to a removable, non-volatile optical disk such as a CD-ROM, DVD-ROM or other optical media may be provided. In such instances, each can be connected to bus 406 by one or more data media interfaces. As will be further depicted and described below, the system memory 404 may include at least one program product having a set (e.g., at least one) of program modules that are configured to carry out the functions of embodiments of the present disclosure.

The program/utility, having a set (at least one) of program modules 416, may be stored in the system memory 404 by way of example, and not limiting, as well as an operating system, one or more application programs, other program modules, and program data. Program modules may include one or more of the buffer component 110, the sampling component 120, the action component 130, the evaluation component 140, and the policy component 150, which are illustrated in FIG. 1. Each of the operating systems, one or more application programs, other program modules, and program data or some combination thereof, may include an implementation of a networking environment. Program modules 416 generally carry out the functions and/or methodologies of embodiments of the present disclosure, as described herein.

The computer system/server 400 may also communicate with one or more external devices 418 such as a keyboard, a pointing device, a display 420, etc.; one or more devices that enable a user to interact with computer system/server 400; and/or any devices (e.g., network card, modem, etc.) that enable computer system/server 400 to communicate with one or more other computing devices. Such communication can occur via Input/Output (I/O) interfaces 414. Still yet, computer system/server 400 may communicate with one or more networks such as a local area network (LAN), a general wide area network (WAN), and/or a public network (e.g., the Internet) via network adapter 422. As depicted, network adapter 422 may communicate with the other components of computer system/server 400 via bus 406. It should be understood that, although not shown, other hardware and/or software components could be used in conjunction with computer system/server 400. Examples include, but are not limited to: microcode, device drivers, redundant processing units, external disk drive arrays, RAID systems, tape drives, and data archival storage systems, etc.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Service models may include software as a service (SaaS), platform as a service (PaaS), and infrastructure as a service (IaaS). In SaaS, the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings. In PaaS, the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations. In IaaS, the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment models may include private cloud, community cloud, public cloud, and hybrid cloud. In private cloud, the cloud infrastructure is operated solely for an organization. It may be managed by the organization or a third party and may exist on-premises or off-premises. In community cloud, the cloud infrastructure is shared by several organizations and supports specific community that has shared concerns (e.g., mission, security requirements, policy, and compliance considerations). It may be managed by the organizations or a third party that may exist on-premises or off-premises. In public cloud, the cloud infrastructure is made available to the general public or a large industry group and is owned by an organization selling cloud services. In hybrid cloud, the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling modularity, and semantic interoperability. At the heart of cloud computing is an infrastructure that includes a network of interconnected nodes.

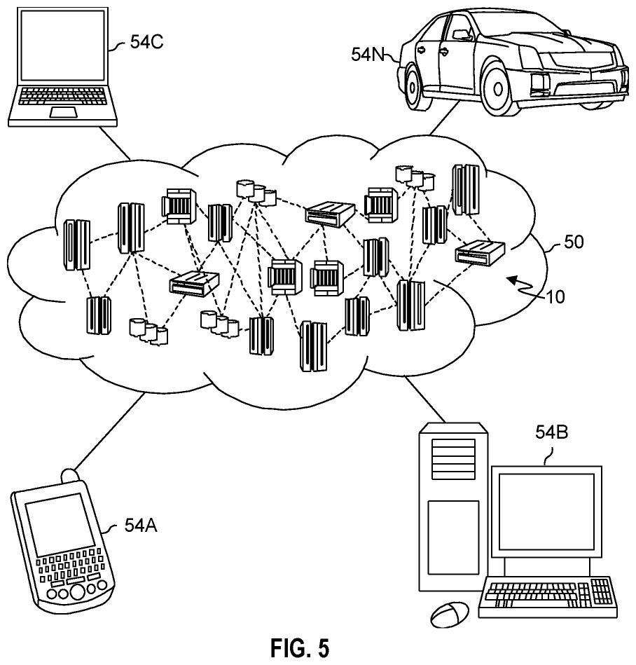

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

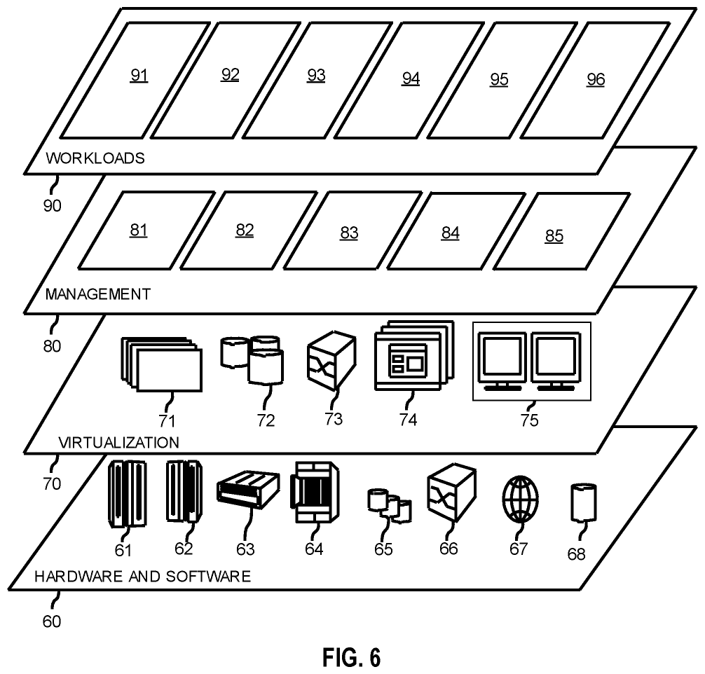

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the disclosure are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and dynamic policy program processing 96.

Cloud models may include characteristics including on-demand self-service, broad network access, resource pooling, rapid elasticity, and measured service. In on-demand self-service a cloud consumer may unilaterally provision computing capabilities such as server time and network storage, as needed automatically without requiring human interaction with the service's provider. In broad network access, capabilities are available over a network and accessed through standard mechanisms that promote use by heterogeneous thin or thick client platforms (e.g., mobile phones, laptops, and PDAs). In resource pooling, the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter). In rapid elasticity, capabilities can be rapidly and elastically provisioned, in some cases automatically, to quickly scale out and rapidly released to quickly scale in. To the consumer, the capabilities available for provisioning often appear to be unlimited and can be purchased in any quantity at any time. In measured service, cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

The descriptions of the various embodiments of the present disclosure have been presented for purposes of illustration, but are not intended to be exhaustive or limited to the embodiments disclosed. Many modifications and variations will be apparent to those of ordinary skills in the art without departing from the scope and spirit of the described embodiments. The terminology used herein was chosen to best explain the principles of the embodiments, the practical application or technical improvement over technologies found in the marketplace, or to enable others of ordinary skills in the art to understand the embodiments disclosed herein.

The present invention may be embodied as a system, a method, and/or a computer program product. The computer program product may include a computer-readable storage medium (or media) having computer readable program instructions thereon for causing a processor to carry out aspects of the present invention.

The computer-readable storage medium may be an electronic, magnetic, optical, electromagnetic, infrared or a semi-conductor system for a propagation medium. Examples of a computer-readable medium may include a semi-conductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W), DVD and Blu-Ray-Disk.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disk read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer-readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Smalltalk, C++ or the like, and conventional procedural programming languages, such as the “C” programming language or similar programming languages. The computer readable program instructions may execute entirely on the user's computer, partly on the user's computer as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatuses, or another device to cause a series of operational steps to be performed on the computer, other programmable apparatus or other device to produce a computer implemented process, such that the instructions which execute on the computer, other programmable apparatuses, or another device implement the functions/acts specified in the flowchart and/or block diagram block or blocks.

The flowcharts and/or block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or act or carry out combinations of special purpose hardware and computer instructions.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will further be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of the present disclosure has been presented for purposes of illustration and description, but is not intended to be exhaustive or limited to the present disclosure in the form disclosed. Many modifications and variations will be apparent to those of ordinary skills in the art without departing from the scope of the present disclosure. The embodiments are chosen and described in order to explain the principles of the present disclosure and the practical application, and to enable others of ordinary skills in the art to understand the present disclosure for various embodiments with various modifications, as are suited to the particular use contemplated.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A computer-implemented method, comprising:
generating a replay buffer including a set of transitions from a set of states, a set of actions based on a current policy, a set of subsequent states based on the set of actions, and a set of rewards based on the set of actions;
sampling a plurality of transitions from the replay buffer as a set of samples;
generating an action value based on a dynamic policy programming (DPP) recursion using the set of samples and a first hyperparameter;
evaluating the policy by computing a KL divergence using the set of samples, the action value and a second hyperparameter; and
generating a subsequent policy by updating the current policy by minimizing a sum of two KL divergences and using a third hyperparameter.

2. The method of claim 1, wherein each transition included in the replay buffer is representative of a first state, an action based on a current policy, a subsequent state based on the first state and the action, and a reward based on the first state and the action.

3. The method of claim 1, wherein generating the action value further comprises:
approximating a DPP-based error using double Q learning and at least one target network from samples associated with the first hyperparameter.

4. The method of claim 3, wherein minimization is used for a Bellman backup term and maximization is used for an advantage term in double Q learning.

5. The method of claim 4, wherein generating the action value further comprises:
performing a gradient descent to minimize the DPP-based error.

6. The method of claim 1, wherein generating the subsequent policy further comprises:
approximating a first KL divergence between a candidate policy and a DPP-induced policy from samples associated with a second hyperparameter; and
approximating a second KL divergence between the candidate policy and the current policy from the set of samples.

7. The method of claim 6, wherein generating the subsequent policy further comprises:
performing a gradient descent to minimize a sum of the first KL divergence and the second KL divergence with a third hyperparameter.

8. A system, comprising:
one or more processors; and
a computer-readable storage medium, coupled to the one or more processors, storing program instructions that, when executed by the one or more processors, cause the one or more processors to perform operations comprising:
generating a replay buffer including a set of transitions from a set of states, a set of actions based on a current policy, a set of subsequent states based on the set of actions, and a set of rewards based on the set of actions;
sampling a plurality of transitions from the replay buffer as a set of samples;
generating an action value based on a dynamic policy programming (DPP) recursion using the set of samples and a first hyperparameter;
evaluating the policy by computing a KL divergence using the set of samples, the action value and a second hyperparameter; and
generating a subsequent policy by updating the current policy by minimizing a sum of two KL divergence and using a third hyperparameter.

9. The system of claim 8, wherein each transition included in the replay buffer is representative of a first state, an action based on a current policy, a subsequent state based on the first state and the action, and a reward based on the first state and the action.

10. The system of claim 8, wherein generating the action value further comprises:
approximating a DPP-based error using double Q learning and at least one target network from samples associated with the first hyperparameter.

11. The system of claim 10, wherein minimization is used for a Bellman backup term and maximization is used for an advantage term in double Q learning.

12. The system of claim 11, wherein generating the action value further comprises:
performing a gradient descent to minimize the DPP-based error.

13. The system of claim 8, wherein generating the subsequent policy further comprises:
approximating a first KL divergence between a candidate policy and a DPP-induced policy from samples associated with a second hyperparameter; and
approximating a second KL divergence between the candidate policy and the current policy from the set of samples.

14. The system of claim 13, wherein generating the subsequent policy further comprises:
performing a gradient descent to minimize a sum of the first KL divergence and the second KL divergence with a third hyperparameter.

15. A computer program product comprising a computer readable storage medium having program instructions embodied therewith, the program instructions being executable by one or more processors to cause the one or more processors to perform operations comprising:
generating a replay buffer including a set of transitions from a set of states, a set of actions based on a current policy, a set of subsequent states based on the set of actions, and a set of rewards based on the set of actions;
sampling a plurality of transitions from the replay buffer as a set of samples;
generating an action value based on a dynamic policy programming (DPP) recursion using the set of samples and a first hyperparameter;
evaluating the policy by computing a KL divergence using the set of samples, the action value and a second hyperparameter; and
generating a subsequent policy by updating the current policy by minimizing a sum of two KL divergence and using a third hyperparameter.

16. The computer program product of claim 15, wherein each transition included in the replay buffer is representative of a first state, an action based on a current policy, a subsequent state based on the first state and the action, and a reward based on the first state and the action.

17. The computer program product of claim 15, wherein generating the action value further comprises:
approximating a DPP-based error using double Q learning and at least one target network from samples associated with the first hyperparameter.

18. The computer program product of claim 17, wherein minimization is used for a Bellman backup term and maximization is used for an advantage term in double Q learning, and wherein generating the action value further comprises:
performing a gradient descent to minimize the DPP-based error.

19. The computer program product of claim 15, wherein generating the subsequent policy further comprises:
approximating a first KL divergence between a candidate policy and a DPP-induced policy from samples associated with a second hyperparameter; and
approximating a second KL divergence between the candidate policy and the current policy from the set of samples.

20. The computer program product of claim 19, wherein generating the subsequent policy further comprises:
performing a gradient descent to minimize a sum of the first KL divergence and the second KL divergence with a third hyperparameter.
